(19) United States
(12) Patent Application Publication
(10) Pub. No.: US 2020/0082960 A1
(43) Pub. Date: Mar. 12, 2020

(54) SUPERCONDUCTING WIRE AND METHOD FOR FABRICATING THE SAME

(71) Applicant: SUMITOMO ELECTRIC INDUSTRIES, LTD., Osaka-shi, Osaka (JP)

(72) Inventors: Kotaro OHKI, Osaka-shi, Osaka (JP); Genki HONDA, Osaka-shi, Osaka (JP)

(73) Assignee: SUMITOMO ELECTRIC INDUSTRIES, LTD., Osaka-shi, Osaka (JP)

(21) Appl. No.: 16/469,803

(22) PCT Filed: Dec. 16, 2016
(86) PCT No.: PCT/JP2016/087664

§ 371 Date: Jun. 14, 2019

(51) Int. Cl. H01B 12/06

(52) U.S. Cl. CPC H01B 12/06

(57) ABSTRACT

A superconducting wire includes a metal substrate, an intermediate layer on the metal substrate, a superconducting material layer on the intermediate layer, and a cover layer on the superconducting material layer. The cover layer includes a protective layer on the superconducting material layer. A first stack formed by the intermediate layer and the superconducting material layer has a breakdown voltage of 1.1 V or greater.

### TECHNICAL FIELD

The present invention relates to a superconducting wire and a method for fabricating the same.

### BACKGROUND ART

WO 2013/165001 (PTL 1) discloses a superconducting wire which includes a metal substrate, an intermediate layer on the metal substrate, a superconducting material layer on the intermediate layer, and a protective layer on the superconducting material layer.

### CITATION LIST

### Patent Literature

PTL 1: WO 2013/165001

### SUMMARY OF INVENTION

A superconducting wire according to one aspect of the present invention includes a metal substrate, an intermediate layer on the metal substrate, a superconducting material layer on the intermediate layer, and a cover layer on the superconducting material layer. The cover layer includes a protective layer on the superconducting material layer. A first stack formed by the intermediate layer and the superconducting material layer has a breakdown voltage of 1.1 V or greater.

A method for fabricating the superconducting wire according to one aspect of the present invention includes forming the intermediate layer on the metal substrate, forming the superconducting material layer on the intermediate layer, and forming the cover layer on the superconducting material layer. Forming the cover layer includes forming the protective layer on the superconducting material layer. The first stack formed by the intermediate layer and the superconducting material layer has a breakdown voltage of 1.1 V or greater.

### BRIEF DESCRIPTION OF DRAWINGS

FIG. 1 is a schematic cross-sectional view of a superconducting wire according to Embodiment 1.

FIG. 2 is a schematic cross-sectional view illustrating a method of measuring a breakdown voltage of the superconducting wire according to Embodiment 1.

FIG. 3 is a schematic plan view illustrating the method of measuring the breakdown voltage of the superconducting wire according to Embodiment 1.

FIG. 4 is a schematic enlarged partial cross section of a region IV of the superconducting wire according to Embodiment 1 shown in FIG. 1.

FIG. 5 is a flowchart for a method for fabricating the superconducting wire according to Embodiment 1.

FIG. 6 is a flowchart illustrating a process of forming a cover layer in the method for fabricating the superconducting wire according to Embodiment 1.

FIG. 7 is a schematic cross-sectional view illustrating one process in the method for fabricating the superconducting wire according to Embodiment 1.

FIG. 8 is a schematic cross-sectional view illustrating one process in a method for fabricating a superconducting wire according to Comparative Example.

FIG. 9 is a schematic cross-sectional view of a superconducting wire according to Embodiment 2.

### DETAILED DESCRIPTION

### Problem to be Solved by the Present Disclosure

An object of the present disclosure is to provide a superconducting wire having a high critical current I_{c} and a method for fabricating the same.

### Advantageous Effect of the Present Disclosure

According to the superconducting wire above, a superconducting wire having high critical current I_{c} can be provided. According to the method for fabricating the superconducting wire above, a superconducting wire having high critical current I_{c} can be fabricated.

### Description of Embodiments

Initially, embodiments of the present invention will be described in a list.

(1) A superconducting wire according to one aspect of the present invention includes a metal substrate, an intermediate layer on the metal substrate, a superconducting material layer on the intermediate layer, and a cover layer on the superconducting material layer. The cover layer includes a protective layer on the superconducting material layer. A first stack formed by the intermediate layer and the superconducting material layer has a breakdown voltage of 1.1 V or greater. The superconducting wire according to one aspect of the present invention has high critical current I_{c}.

(2) In the superconducting wire according to (1) above, a minimum gap between the protective layer and the metal substrate in the central region of the superconducting wire in the width direction may be 95% or greater and 100% or less than the thickness of the first stack in the direction of thickness of the superconducting wire. The superconducting wire according to one aspect of the present invention has high critical current I_{c}.

(3) In the superconducting wire according to (1) or (2) above, the protective layer in a cross section perpendicular to the longitudinal direction of the superconducting wire may cover the outer periphery of a second stack formed by the metal substrate and the first stack. According to the superconducting wire of one aspect of the present invention, the superconducting wire can be prevented from being damaged upon transition of the superconducting material layer from a superconducting state to a normal conducting state.

(4) In the superconducting wire according to any of (1) through (3) above, the cover layer may further include a stabilization layer on the protective layer.

According to the superconducting wire of one aspect of the present invention, the superconducting wire can be prevented from being damaged upon transition of the superconducting material layer from the superconducting state to the normal conducting state.

(5) The method for fabricating the superconducting wire according to one aspect of the present invention includes forming the intermediate layer on the metal substrate, forming the superconducting material layer on the intermediate layer, and forming the cover layer on the superconducting material layer. Forming the cover layer includes forming the protective layer on the superconducting material layer by sputtering. The first stack formed by the intermediate layer and the superconducting material layer has a breakdown voltage of 1.1 V or greater. According to the method for fabricating the superconducting wire of one aspect of the present invention, a superconducting wire having high critical current I_{c} can be fabricated.

### DETAILS OF EMBODIMENTS OF THE PRESENT INVENTION

Hereinafter, a superconducting wire according to embodiments of the present invention will be described. Note that like reference numbers refer to like configurations, and the description thereof will not be repeated.

### Embodiment 1

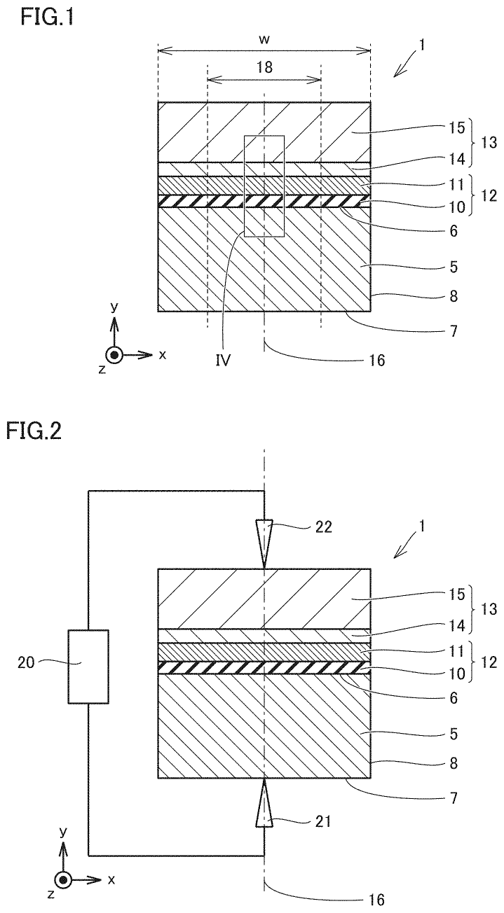

Referring to FIGS. 1 to 4, a superconducting wire 1 according to the present embodiment mainly includes a metal substrate 5, an intermediate layer 10 on metal substrate 5, a superconducting material layer 11 on intermediate layer 10, and a cover layer 13 on superconducting material layer 11. Cover layer 13 includes a protective layer 14 on superconducting material layer 11. Cover layer 13 may further include a stabilization layer 15 on protective layer 14. In the present embodiment, cover layer 13 may consist of protective layer 14 and stabilization layer 15.

Superconducting wire 1 is a long wire extending in the longitudinal direction (z direction). The length of superconducting wire 1 in the longitudinal direction (z direction) is longer than the thickness and width w of superconducting wire 1. In the present specification, width w of superconducting wire 1 is defined as a maximum length of superconducting wire 1 in a direction (x direction) perpendicular to: a direction (y direction) in which intermediate layer 10, superconducting material layer 11, and cover layer 13 are stacked; and the longitudinal direction (z direction) of superconducting wire 1. The width direction (x direction) of superconducting wire 1 is defined as the direction (x direction) perpendicular to: the direction (y direction) in which intermediate layer 10, superconducting material layer 11, and cover layer 13 are stacked; and the longitudinal direction (z direction) of superconducting wire 1. The thickness of superconducting wire 1 is defined as a maximum length of superconducting wire 1 in the direction (y direction) in which intermediate layer 10, superconducting material layer 11, and cover layer 13 are stacked. The direction of thickness (y direction) of superconducting wire 1 is defined as the direction (y direction) in which intermediate layer 10, superconducting material layer 11, and cover layer 13 are stacked.

Metal substrate 5 may be a textured metal substrate. The textured metal substrate refers to metal substrate 5 whose crystal orientation on the surface is aligned. The textured metal substrate may be, for example, a clad-type metal substrate in which, for example, a nickel layer and a copper layer are disposed on a SUS or Hastelloy (registered trademark) base metal substrate.

Metal substrate 5 has a first primary surface 6, a second primary surface 7 opposite the first primary surface 6, and a side face 8 connecting first primary surface 6 and second primary surface 7. Metal substrate 5 has a thickness greater than those of other components (intermediate layer 10, superconducting material layer 11, and cover layer 13) included in superconducting wire 1. Metal substrate 5 may have a thickness of, but not particularly limited to, 30 μm or greater, and particularly 50 μm or greater. Considering the productivity and cost of metal substrate 5, metal substrate 5 may have a thickness of 1 mm or less, and particularly 200 μm or less. The thickness of metal substrate 5 is defined as a maximum distance between first primary surface 6 and second primary surface 7 of metal substrate 5.

Intermediate layer 10 is provided on first primary surface 6 of metal substrate 5. Intermediate layer 10 is disposed between metal substrate 5 and superconducting material layer 11. A material can be used for intermediate layer 10, which has significantly low reactivity with superconducting material layer 11 and prevents reduction in superconducting characteristics of superconducting material layer 11. Intermediate layer 10 can inhibit diffusion of metal atoms from metal substrate 5 into superconducting material layer 11 when forming superconducting material layer 11 using a high temperature process. When metal substrate 5 has crystal orientation on the surface, intermediate layer 10 may mitigate the difference in crystal orientation between metal substrate 5 and superconducting material layer 11. Intermediate layer 10 may have a thickness of 0.1 μm or greater and 3.0 μm or less, for example.

Intermediate layer 10 may be composed of at least one of, for example, YSZ (yttria-stabilized zirconia), CeO₂ (cerium oxide), MgO (magnesium oxide), Y₂O₃ (yttrium oxide), Al₂O₃ (aluminum oxide), LaMnO₃ (lanthanum manganese oxide), Gd₂Zr₂O₇ (gadolinium zirconate), and SrTiO₃ (strontium titanate). Intermediate layer 10 may be composed of multiple layers. When intermediate layer 10 is composed of multiple layers, the multiple layers may be composed of different materials, or some of the multiple layers may be composed of the same material and the rest may be composed of different materials. When a SUS substrate or a Hastelloy substrate is used as metal substrate 5, intermediate layer 10 may be a crystal alignment layer formed by IBAD (Ion Beam Assisted Deposition), for example.

Superconducting material layer 11 may be provided on a primary surface, of intermediate layer 10, opposite a primary surface facing the metal substrate 5. Superconducting material layer 11 may be provided on first primary surface 6 of metal substrate 5 with intermediate layer 10 inbetween. Superconducting material layer 11 is a portion of superconducting wire 1 through which a supercurrent flows. Preferably, the superconducting material making up the superconducting material layer 11 is, but not particularly limited to, an RE-123-based oxide superconductor, for example. The RE-123-based oxide superconductor refers to a superconductor represented by REBa₂Cu₃O_{y}, where y is 6 to 8, and more preferably 6.8 to 7, and RE refers to a rare-earth element such as Gd, Sm, and Ho.

To increase the critical current I_{c} of the supercurrent through superconducting material layer 11, superconducting material layer 11 may have a thickness of, but not particularly limited to, 0.5 μm or greater, and particularly 1.0 μm or greater. Considering the productivity of superconducting material layer 11, the thickness of superconducting material layer 11 may be 10 μm or less and particularly 5 μm or less. Superconducting material layer 11 may have a thickness greater than intermediate layer 10.

Protective layer 14 is formed on a primary surface, of superconducting material layer 11, opposite a primary surface facing intermediate layer 10. Protective layer 14 may be composed of a conductive material. Protective layer 14 may be composed of, for example, silver (Ag) or a silver alloy. Protective layer 14 serves as a bypass to which a current flow in superconducting material layer 11 in the superconducting state commutates upon transition of superconducting material layer 11 to the normal conducting state. Protective layer 14 may have a thickness of, for example, 0.1 μm or greater, and particularly 1 μm or greater. Protective layer 14 may have a thickness of, for example, 20 μm or less, and particularly 10 μm or less.

Stabilization layer 15 may be provided on protective layer 14. Protective layer 14 may be disposed between superconducting material layer 11 and stabilization layer 15. Stabilization layer 15 serves, together with protective layer 14, as a bypass to which a current flow in superconducting material layer 11 in the superconducting state commutates upon transition of superconducting material layer 11 to the normal conducting state. Stabilization layer 15 may be a layer of a metal having good electrical conductivity, such as copper (Cu) or a copper alloy, for example. Stabilization layer 15 may have a thickness of, but not particularly limited to, 10 μm or greater, and particularly 20 μm or greater. Stabilization layer 15 may have a thickness of 100 μm or less, and particularly 50 μm or less. Stabilization layer 15 has a thickness greater than protective layer 14.

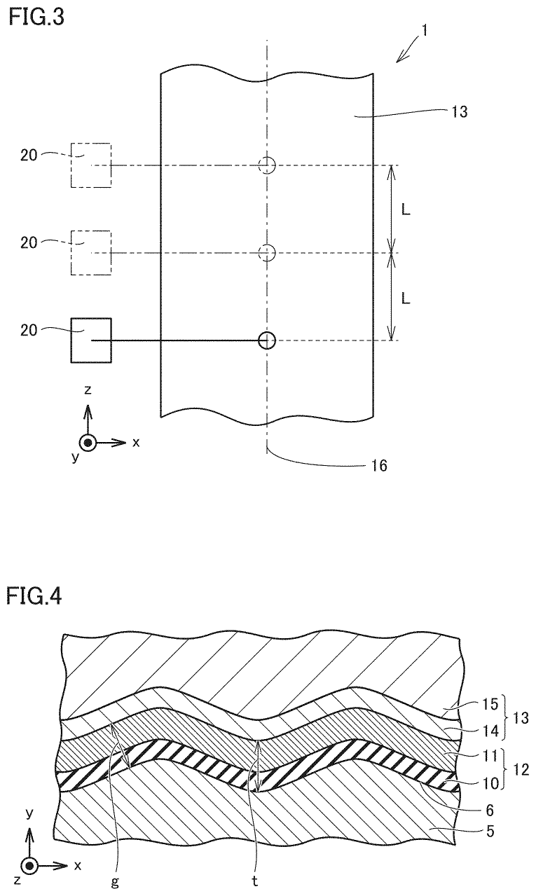

Intermediate layer 10 and superconducting material layer 11 are configured such that first stack 12 formed by intermediate layer 10 and superconducting material layer 11 has a breakdown voltage of 1.1 V or greater. The breakdown voltage of first stack 12 may be 1.5 V or greater, or 1.8V or greater. As shown in FIGS. 2 and 3, in the present specification, the breakdown voltage of first stack 12 is defined as an average value of the breakdown voltage of first stack 12 at a central portion 16 of superconducting wire 1 in the width direction (x direction), the average value being measured at three locations in superconducting wire 1 in the longitudinal direction (z direction). The three locations in superconducting wire 1 in the longitudinal direction (z direction) are apart from one another by 1 cm in the longitudinal direction (z direction) of superconducting wire 1. The three locations in superconducting wire 1 in the longitudinal direction (z direction) are apart, by at least a distance L, from both ends (not shown) of superconducting wire 1 in the longitudinal direction (z direction).

The breakdown voltage of first stack 12 is measured by electrically connecting metal substrate 5 and cover layer 13 to a measuring device 20. Specifically, a first probe 21 connected to measuring device 20 is brought into contact with central portion 16 of metal substrate 5 in the width direction (x direction), and a second probe 22 connected to measuring device 20 is brought into contact with central portion 16 of cover layer 13 in the width direction (x direction), thereby measuring the breakdown voltage of first stack 12. Since metal substrate 5 and cover layer 13 have electrical conductivity, metal substrate 5 and cover layer 13 do not contribute to electrical breakdown of superconducting wire 1. Thus, the breakdown voltage of first stack 12 can be measured by electrically connecting metal substrate 5 and cover layer 13 to measuring device 20.

Referring to FIG. 4, metal substrate 5 may have uneven first primary surface 6. Referring to FIGS. 1 and 4, a minimum gap g between protective layer 14 and metal substrate 5 in a central region 18 of superconducting wire 1 in the width direction (x direction) may be 95% or greater and 100% or less than a thickness t of first stack 12 in the direction of thickness (y direction) of superconducting wire 1. In the present specification, central region 18 of superconducting wire 1 in the width direction (x direction) is defined as a region between a pair of lines offset from central portion 16 of superconducting wire 1 in the width direction (x direction) by 0.30 w in the width direction (plus and minus x direction) of superconducting wire 1.

Electrical breakdown of first stack 12 is most likely to occur at a location in superconducting wire 1 where the gap between protective layer 14 and metal substrate 5 is smallest. Minimum gap g between protective layer 14 and metal substrate 5 is increased by configuring minimum gap g to be 95% or greater and 100% or less than thickness t of first stack 12 in the direction of thickness (y direction) of superconducting wire 1. Accordingly, the breakdown voltage of first stack 12 is increased and electrical breakdown of first stack 12 is inhibited.

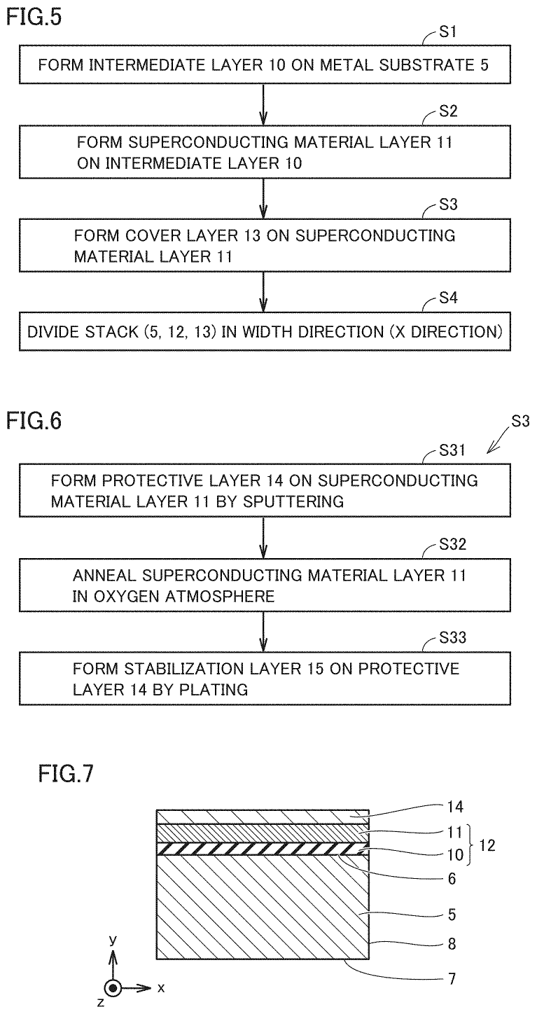

Referring to FIGS. 5 and 6, one example of the method for fabricating superconducting wire 1 according to the present embodiment will be described.

The method for fabricating superconducting wire 1 according to the present embodiment includes forming intermediate layer 10 on metal substrate 5 (Si). Particularly, the method for fabricating superconducting wire 1 according to the present embodiment includes forming intermediate layer 10 on first primary surface 6 of metal substrate 5. A physical vapor deposition method, for example, sputtering, may be employed as a method of forming intermediate layer 10. When first primary surface 6 of metal substrate 5 has no oriented crystallization, intermediate layer 10 having oriented crystallization may be formed by IBAD (Ion Beam Assisted Deposition).

The method for fabricating superconducting wire 1 according to the present embodiment includes forming superconducting material layer 11 on intermediate layer 10 (S2). Specifically, superconducting material layer 11 containing an RE-123-based oxide superconductor may be formed on the primary surface, of intermediate layer 10, opposite the primary surface facing the metal substrate 5. Superconducting material layer 11 may be formed by, for example, vapor deposition, liquid phase deposition, or a combination thereof. Examples of the vapor deposition can include PLD (Pulsed Laser Deposition), sputtering, electron beam deposition, MOCVD (Metal-Organic Chemical Vapor Deposition), or MBE (Molecular Beam Epitaxy). Examples of the liquid phase deposition can include MOD (Metal Organic Deposition).

The method for fabricating superconducting wire 1 according to the present embodiment includes forming cover layer 13 on superconducting material layer 11 (S3). Forming cover layer 13 (S3) includes forming protective layer 14 on superconducting material layer 11 by sputtering (S31). Forming cover layer 13 (S3) may include annealing superconducting material layer 11 in oxygen atmosphere (S32). Annealing superconducting material layer 11 in oxygen atmosphere allows introduction of oxygen into superconducting material layer 11. Forming cover layer 13 (S3) may further include forming stabilization layer 15 on protective layer 14 by plating (S33).

The method for fabricating superconducting wire 1 according to the present embodiment may further include dividing a stack (5, 12, 13), formed by metal substrate 5, first stack 12, and cover layer 13, in the width direction (x direction) of the stack (5, 12, 13) (S4). In one example, the stack (5, 12, 13) may be divided by irradiating it with a laser beam. In another example, the stack (5, 12, 13) may be divide d by mechanically cutting (machine slitting) it using a rotary blade. Superconducting wire 1 according to the present embodiment can be fabricated by the above steps.

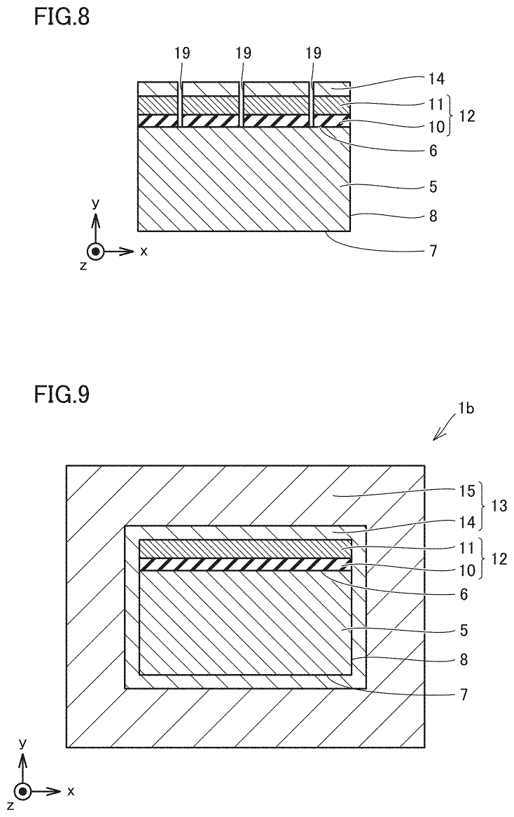

In superconducting wire 1 according to the present embodiment, first stack 12 formed by intermediate layer 10 and superconducting material layer 11 has a breakdown voltage of 1.1 V or greater. In the method for fabricating superconducting wire 1 according to the present embodiment, in the step (S1) of forming intermediate layer 10 and the step (S2) of forming superconducting material layer 11, intermediate layer 10 and superconducting material layer 11 are formed so that first stack 12 formed by intermediate layer 10 and superconducting material layer 11 has the breakdown voltage of 1.1 V or greater. For example, the materials and thickness of intermediate layer 10 and superconducting material layer 11 may be selected such that the breakdown voltage of first stack 12 is 1.1 V or greater. Since the breakdown voltage of first stack 12 is 1.1 V or greater, in the step (S31) of forming protective layer 14 on superconducting material layer 11 by sputtering as shown in FIG. 7, electrical breakdown is prevented from occurring in first stack 12 even when intermediate layer 10 and superconducting material layer 11 are charged. Thus, the step (S31) of forming protective layer 14 on superconducting material layer 11 by sputtering does not cause defects 19 (see FIG. 8) in intermediate layer 10, superconducting material layer 11, and protective layer 14. Superconducting wire 1 according to the present embodiment has high critical current I_{c}.

On the other hand, in a superconducting wire according to Comparative Example, a first stack 12 formed by an intermediate layer 10 and a superconducting material layer 11 has a breakdown voltage of less than 1.1 V. In a method for fabricating the superconducting wire according to Comparative Example, in a step (S1) of forming intermediate layer 10 and a step (S2) of forming superconducting material layer 11, intermediate layer 10 and superconducting material layer 11 are formed so that first stack 12 formed by intermediate layer 10 and superconducting material layer 11 has a breakdown voltage of less than 1.1 V. Thus, as shown in FIG. 8, in the superconducting wire according to Comparative Example, in a step (S31) of forming a protective layer 14 on superconducting material layer 11 by sputtering, electrical breakdown can occur in first stack 12 when intermediate layer 10 and superconducting material layer 11 are charged. Thus, the step (S31) of forming protective layer 14 on superconducting material layer 11 by sputtering can cause defects 19 in intermediate layer 10, superconducting material layer 11, and protective layer 14. The superconducting wire according to Comparative Example has low critical current I_{c}.

Advantageous effects of superconducting wire 1 according to the present embodiment and the method for fabricating the same will be described.

Superconducting wire 1 according to the present embodiment includes metal substrate 5, intermediate layer 10 on metal substrate 5, superconducting material layer 11 on intermediate layer 10, and cover layer 13 on superconducting material layer 11. Cover layer 13 includes protective layer 14 on superconducting material layer 11. First stack 12 formed by intermediate layer 10 and superconducting material layer 11 has a breakdown voltage of 1.1 V or greater. Since first stack 12 has the breakdown voltage of 1.1 V or greater, defects 19 can be prevented from occurring in intermediate layer 10, superconducting material layer 11, and protective layer 14. Superconducting wire 1 according to the present embodiment has high critical current I_{c}.

In superconducting wire 1 according to the present embodiment, minimum gap g between protective layer 14 and metal substrate 5 in central region 18 of superconducting wire 1 in the width direction (x direction) may be 95% or greater and 100% or less than thickness t of first stack 12 in the direction of thickness (y direction) of superconducting wire 1. Thus, defects 19 can be prevented from occurring in intermediate layer 10, superconducting material layer 11, and protective layer 14. Superconducting wire 1 according to the present embodiment has high critical current I_{c}.

In superconducting wire 1 according to the present embodiment, cover layer 13 may further include stabilization layer 15 on protective layer 14. Stabilization layer 15 serves as a bypass to which a current flow in superconducting material layer 11 in the superconducting state commutates upon transition of superconducting material layer 11 to the normal conducting state. Superconducting wire 1 can be prevented from being damaged upon transition of superconducting material layer 11 from the superconducting state to the normal conducting state.

The method for fabricating superconducting wire 1 according to the present embodiment includes forming intermediate layer 10 on metal substrate 5 (S1), forming superconducting material layer 11 on intermediate layer 10 (S2), and forming cover layer 13 on superconducting material layer 11 (S3). Forming cover layer 13 (S3) includes forming protective layer 14 on superconducting material layer 11 by sputtering (S31). First stack 12 formed by intermediate layer 10 and superconducting material layer 11 has a breakdown voltage of 1.1 V or greater. Since first stack 12 has the breakdown voltage of 1.1 V or greater, defects 19 can be prevented from occurring in intermediate layer 10, superconducting material layer 11, and protective layer 14. According to the method for fabricating superconducting wire 1 of the present embodiment, superconducting wire 1 having high critical current I_{c} can be fabricated.

In the method for fabricating superconducting wire 1 according to the present embodiment, minimum gap g between protective layer 14 and metal substrate 5 in central region 18 of superconducting wire 1 in the width direction (x direction) may be 95% or greater and 100% or less than thickness t of first stack 12 in the direction of thickness (y direction) of superconducting wire 1. Thus, defects 19 can be prevented from occurring in intermediate layer 10, superconducting material layer 11, and protective layer 14. According to the method for fabricating superconducting wire 1 of the present embodiment, superconducting wire 1 having high critical current I_{c} can be fabricated.

In the method for fabricating superconducting wire 1 according to the present embodiment, forming cover layer 13 may further include forming stabilization layer 15 on protective layer 14 by plating (S33). Stabilization layer 15 serves as a bypass to which a current flow in superconducting material layer 11 in the superconducting state commutates upon transition of superconducting material layer 11 to the normal conducting state. Superconducting wire 1 can be prevented from being damaged upon transition of superconducting material layer 11 from the superconducting state to the normal conducting state. Moreover, defects 19 can be prevented from occurring in intermediate layer 10, superconducting material layer 11, and protective layer 14. According to the method for fabricating superconducting wire 1 of the present embodiment, during the process (S33) of forming stabilization layer 15 by plating, intermediate layer 10 and superconducting material layer 11 can be prevented from being damaged by the plating solution.

### Embodiment 2

Referring to FIG. 9, a superconducting wire 1b according to Embodiment 2 will be described. Superconducting wire 1b according to the present embodiment has the same configuration as superconducting wire 1 according to Embodiment 1, except for the following.

In superconducting wire 1b according to the present embodiment, a cover layer 13 covers the outer periphery of a second stack (5, 12), formed by a metal substrate 5 and a first stack 12, in a cross section (x-y plane) perpendicular to the longitudinal direction (z direction) of superconducting wire 1b. Cover layer 13 may be further provided on the side face of superconducting material layer 11, on the side face of an intermediate layer 10, a side face 8 of metal substrate 5, and a second primary surface 7 of metal substrate 5.

In the cross section (x-y plane) perpendicular to the longitudinal direction (z direction) of superconducting wire 1b, a protective layer 14 covers the outer periphery of the second stack (5, 12) formed by metal substrate 5 and first stack 12. Protective layer 14 may further be provided on the side face of superconducting material layer 11, the side face of intermediate layer 10, side face 8 of metal substrate 5, and second primary surface 7 of metal substrate 5.

A stabilization layer 15 may be provided on protective layer 14. In the cross section (x-y plane) perpendicular to the longitudinal direction (z direction) of superconducting wire 1b, stabilization layer 15 may cover the outer periphery of a stack (5, 12, 14b) composed of the second stack (5, 12) and protective layer 14. Stabilization layer 15 may further be provided on the side face of superconducting material layer 11, the side face of intermediate layer 10, side face 8 of metal substrate 5, and second primary surface 7 of metal substrate 5, with protective layer 14 inbetween.

A method for fabricating superconducting wire 1b according to the present embodiment includes the same steps as those of the method for fabricating superconducting wire 1 according to Embodiment 1, except for the following.

In the method for fabricating superconducting wire 1b according to the present embodiment, forming cover layer 13 (S3) includes forming cover layer 13 covering the outer periphery of the second stack (5, 12) formed by metal substrate 5 and first stack 12. Specifically, forming cover layer 13 (S3) further includes forming cover layer 13 on the side face of superconducting material layer 11, the side face of intermediate layer 10, side face 8 of metal substrate 5, and second primary surface 7 of metal substrate 5.

Forming protective layer 14 (S31) includes forming protective layer 14 so as to cover the outer periphery of the second stack (5, 12) formed by metal substrate 5 and first stack 12. Specifically, forming protective layer 14 (S31) includes further forming protective layer 14 on the side face of superconducting material layer 11, the side face of intermediate layer 10, side face 8 of metal substrate 5, and second primary surface 7 of metal substrate 5. Forming stabilization layer 15 (S33) may include further forming stabilization layer 15 on the side face of superconducting material layer 11, the side face of intermediate layer 10, side face 8 of metal substrate 5, and second primary surface 7 of metal substrate 5, with protective layer 14 inbetween.

In superconducting wire 1b according to the present embodiment, the breakdown voltage of first stack 12 is measured as follows. Cover layer 13 is peeled off metal substrate 5 to expose the entirety of metal substrate 5 from cover layer 13.

Then, metal substrate 5, exposed from cover layer 13, and cover layer 13 are electrically connected to a measuring device 20 (see FIGS. 2 and 3). In this manner, the breakdown voltage of first stack 12 in superconducting wire 1b according to the present embodiment is measured.

Advantageous effects of superconducting wire 1b and the method for fabricating the same according to the present embodiment will be described. Superconducting wire 1b and the method for fabricating the same according to the present embodiment yield the following advantages effects, in addition to the advantages effects of superconducting wire 1 and the method for fabricating the same according to Embodiment 1.

In superconducting wire 1b according to the present embodiment, protective layer 14 may cover the outer periphery of the second stack (5, 12), formed by metal substrate 5 and first stack 12, in the cross section (x-y plane) perpendicular to the longitudinal direction (z direction) of superconducting wire 1b. Thus, intermediate layer 10 and superconducting material layer 11 can be protected by protective layer 14 from environment surrounding superconducting wire 1b. Moreover, protective layer 14 according to the present embodiment has a volume greater than that of protective layer 14 according to Embodiment 1. Thus, superconducting wire 1b can be prevented from being damaged upon transition of superconducting material layer 11 from the superconducting state to the normal conducting state.

In superconducting wire 1b according to the present embodiment, cover layer 13 may further include stabilization layer 15 on protective layer 14. Stabilization layer 15 according to the present embodiment has a volume greater than that of stabilization layer 15 according to Embodiment 1. Thus, superconducting wire 1b can be prevented from being damaged upon transition of superconducting material layer 11 from the superconducting state to the normal conducting state.

In the method for fabricating superconducting wire 1b according to the present embodiment, forming protective layer 14 may include forming protective layer 14 so as to cover the outer periphery of the second stack (5, 12), formed by metal substrate 5 and first stack 12, in the cross section (x-y plane) perpendicular to the longitudinal direction (z direction) of superconducting wire 1b. Thus, intermediate layer 10 and superconducting material layer 11 are protected by protective layer 14 from the environment surrounding superconducting wire 1b. Moreover, protective layer 14 according to the present embodiment has a volume greater than that of protective layer 14 according to Embodiment 1. Thus, superconducting wire 1b can be prevented from being damaged upon transition of superconducting material layer 11 from the superconducting state to the normal conducting state.

In the method for fabricating superconducting wire 1b according to the present embodiment, forming cover layer 13 may further include forming stabilization layer 15 on protective layer 14 by plating. Stabilization layer 15 according to the present embodiment has a volume greater than that of stabilization layer 15 according to Embodiment 1. Thus, superconducting wire 1b can be prevented from being damaged upon transition of superconducting material layer 11 from the superconducting state to the normal conducting state.

Moreover, protective layer 14 covers the outer periphery of the second stack (5, 12), formed by metal substrate 5 and first stack 12, in the cross section (x-y plane) perpendicular to the longitudinal direction (z direction) of superconducting wire 1b. According to superconducting wire 1b of the present embodiment, defects 19 can be prevented from occurring in intermediate layer 10, superconducting material layer 11, and protective layer 14. Thus, in the step (S33) of forming stabilization layer 15 by plating, intermediate layer 10 and superconducting material layer 11 can be prevented from being damaged by the plating solution. A degree of freedom in the selection of the plating solution for the step (S33) of forming stabilization layer 15 using plating can be increased.

The presently disclosed embodiments are should be considered in all aspects illustrative and not restrictive. For example, stabilization layer 15 may be omitted in Embodiments 1 and 2. The scope of the present invention is defined by the appended claims, rather than by the embodiments described above, and all changes which come within the meaning and range of equivalency of the appended claims are intended to be included within the scope of the present invention.

### REFERENCE SIGNS LIST

1, 1b superconducting wire; 5 metal substrate; 6 first primary surface; 7 second primary surface; 8 side face; 10 intermediate layer; 11 superconducting material layer; 12 first stack; 13 cover layer; 14 protective layer; 15 stabilization layer; 16 central portion; 18 central region; 19 defect; 20 measuring device; 21 first probe; and 22 second probe.

1. A superconducting wire, comprising:
a metal substrate;
an intermediate layer on the metal substrate;
a superconducting material layer on the intermediate layer; and
a cover layer on the superconducting material layer,
the cover layer including a protective layer on the superconducting material layer,
a first stack, formed by the intermediate layer and the superconducting material layer, having a breakdown voltage of 1.1 V or greater.

2. The superconducting wire according to claim 1, wherein
a minimum gap between the protective layer and the metal substrate in a central region of the superconducting wire in a width direction is 95% or greater and 100% or less than a thickness of the first stack in a direction of thickness of the superconducting wire.

3. The superconducting wire according to claim 1, wherein
the protective layer covers an outer periphery of a second stack in a cross section perpendicular to a longitudinal direction of the superconducting wire, the second stack being formed by the metal substrate and the first stack.

4. The superconducting wire according to claim 1, wherein
the cover layer further includes a stabilization layer on the protective layer.

5. A method for fabricating a superconducting wire, comprising:
forming an intermediate layer on a metal substrate;
forming a superconducting material layer on the intermediate layer; and
forming a cover layer on the superconducting material layer, wherein
forming the cover layer includes forming a protective layer on the superconducting material layer by sputtering, and
a first stack formed by the intermediate layer and the superconducting material layer has a breakdown voltage of 1.1 V or greater.
